(19) United States
(12) Patent Application Publication
(10) Pub. No.: US 2014/0164946 A1
(43) Pub. Date: Jun. 12, 2014

(54) SYSTEM AND METHOD FOR SELECTIVELY TAGGING RECEIVED MESSAGES

(71) Applicant: OpenPeak Inc., Boca Raton, FL (US)

(72) Inventor: Larry G. Brown, Royal Palm Beach, FL (US)

(21) Appl. No.: 13/937,299

(22) Filed: Jul. 9, 2013

Related U.S. Application Data
(60) Provisional application No. 61/670,359, filed on Jul. 11, 2012.

(51) Int. Cl. H04L 12/58

(52) U.S. Cl. CPC H04L 51/22
USPC 715/752

(57) ABSTRACT

A method and system for selectively tagging received messages is described herein. The method may include the step of delivering a message to a first recipient and a second recipient such that the first recipient receives a copy of the message and the second recipient receives a copy of the message. The method may also include the step of receiving a save command from the first recipient in which the save command is a directive to save the copy of the delivered message received by the first recipient in a database that provides access rights to both the first recipient and the second recipient. In response to the copy of the delivered message received by the first recipient being saved in the database, the copy of the delivered message received by the second recipient can be tagged with a save indicator to enable the second recipient to determine that the delivered message has been saved in the database.

### CROSS-REFERENCE TO RELATED APPLICATIONS

This patent application claims priority to U.S. Patent Application No. 61/670,359, filed on Jul. 11, 2012, which is incorporated herein by reference in its entirety.

### FIELD OF TECHNOLOGY

The present subject matter relates to systems and methods for processing messages in a computing environment.

### BACKGROUND

E-mail messaging is ingrained in the transactions of everyday business, and many organizations believe that it is important to maintain a database for selectively storing these communications. For example, many legal departments of corporations have installed document management systems, which enable various types of documents to be profiled and stored in a database. Once stored, these documents may be easily retrieved by those individuals who have access to the database. As part of this procedure, the document management system may be tied into a messaging platform, such as a corporate email exchange service. In this configuration, employees may save important corporate emails into the database.

A significant inconvenience, however, presents itself in this arrangement. In particular, many important emails are directed to numerous recipients, each of whom may have the ability or responsibility to save the received email into a corporate database. Because there are several individuals who may save such a message into the database, there is a high probability that the same message will be saved multiple times in the database. This duplicative saving needlessly takes up valuable memory space and complicates the electronic record of the database. Moreover, to prevent this scenario, employees must check the relevant database to ensure that the message has not already been saved. This reduces productivity and leads to increased frustration.

### SUMMARY

A method for selectively tagging received messages is described herein. The method can include the step of delivering a message to a first recipient and a second recipient such that the first recipient receives a copy of the message and the second recipient receives a copy of the message. A save command can be received from the first recipient, and the save command can be a directive to save the copy of the delivered message received by the first recipient in a database that provides access rights to both the first recipient and the second recipient. In response to the copy of the delivered message received by the first recipient being saved in the database, the copy of the delivered message received by the second recipient can be tagged with a save indicator to enable the second recipient to determine that the delivered message has been saved in the database.

As an example, the delivered message may be an email that is addressed to both the first recipient and the second recipient. The method can also include the step of automatically deleting the copy of the delivered message received by the second recipient after a predetermined time after the copy of the delivered message received by the second recipient is tagged with the save indicator.

In one embodiment, tagging the copy of the delivered message received by the second recipient with the save indicator may include changing the pre-existing visual characteristics of the copy of the delivered message received by the second recipient. Examples of changing the pre-existing visual characteristics of the copy of the delivered message may include one or more of the following: fading the copy; shading the copy; displaying a graphical user interface save indicator element on the copy; or changing one or more colors of the copy.

In another embodiment, the method can include the step of moving the copy of the message received by the second recipient from a first folder to a second folder. As an example, the second folder may be designated for messages that have been saved in the database.

The method may also include the steps of detecting the removal of the message from the database and in response to the detection, automatically removing the save indicator from the copy of the delivered message received by the second recipient. As another example, when the removal of the message from the database is detected, the method can include the step of determining whether the copy of the message received by the second recipient has been deleted from an account associated with the second recipient. If the copy of the message received by the second recipient has been deleted from the account, the copy of the message can be automatically restored to the account.

In another arrangement, the save indicator may identify the database to which the delivered message was saved. Thus, the delivered message may be saved to any one or more of multiple databases.

A method for managing messages is also described herein. The method can include the step of delivering a message to a first recipient and a second recipient such that the first recipient receives a copy of the message and the second recipient receives a copy of the message. A save command can be received from the first recipient, and the save command is a directive to save the copy of the delivered message received by the first recipient in a database that provides access rights to both the first recipient and the second recipient. In response to the copy of the delivered message received by the first recipient being saved in the database, the copy of the delivered message received by the second recipient can be automatically deleted.

In one embodiment, automatically deleting the copy of the delivered message received by the second recipient may only performed if permission is obtained. As an example, the permission may be obtained either prior to the delivered message being saved in the database or after the delivered message is saved in the database. As another example, the permission may be obtained from the second recipient. The delivered message may be an email that can be addressed to both the first recipient and the second recipient.

A system for selectively tagging received messages is also described herein. The system can include a message database in which the message database may be configured to store a plurality of delivered messages and to provide access rights to a first recipient and a second recipient. The system can also include a message server in which the message server may be communicatively coupled to the message database. The message server may be operable to deliver a message to the first recipient and the recipient such that the first recipient receives a copy of the message and the second recipient receives a copy of the message. The message server may also be operable to receive a save command from the first recipient, and in response to the save command, save the copy of the delivered message received by the first recipient in the message database. In response to saving the copy of the delivered message received by the first recipient in the message database, the message server may also be operable to tag the copy of the delivered message received by the second recipient with a save indicator to enable the second recipient to determine that the delivered message has been saved in the message database.

As an example, the message server may be operable to tag the copy of the delivered message received by the second recipient by changing the pre-existing visual characteristics of the copy of the delivered message received by the second recipient. In one particular example, the message server may be operable to change the pre-existing visual characteristics of the copy of the delivered message received by the second recipient by one or more of the following: fading the copy; shading the copy; displaying a graphical user interface save indicator element on the copy; or changing one or more colors of the copy.

A system for managing messages is also described herein. The system can include a message database in which the message database may be configured to store a plurality of delivered messages and to provide access rights to a first recipient and a second recipient. The system may also include a message server in which the message server is communicatively coupled to the message database. The message server may be operable to deliver a message to the first recipient and the second recipient such that the first recipient receives a copy of the message and the second recipient receives a copy of the message. The message server may also be operable to receive a save command from the first recipient, and in response to the save command, save the copy of the delivered message received by the first recipient in the message database. In response to saving the copy of the delivered message received by the first recipient in the message database, the message server may further be operable to automatically delete the copy of the delivered message received by the second recipient.

In one embodiment, the message server can be further operable to maintain a log that records the deletion of the delivered message received by the second recipient. In another arrangement, the message server may be operable to automatically delete the copy of the delivered message received by the second recipient only if permission is obtained. As an example, the permission may be obtained from the second recipient.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for selectively tagging received messages.

FIG. 2 illustrates an example of a method for selectively tagging received messages is shown.

FIG. 3 illustrates an example of a tagged copy of a message.

FIG. 4 illustrates another example of a tagged copy of a message.

FIG. 5 illustrates another example of a tagged copy of a message.

FIG. 6 illustrates another example of a tagged copy of a message.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components in a unidirectional or bidirectional (or multi-directional) manner, either wirelessly, through a wired connection or a combination of both. A “computing device” is defined as a component that is configured to perform some process or function for a user and includes both mobile and non-mobile devices. An “application” is defined as a program or programs that provide(s) an interface to enable a user to operate a computing device in accordance with one or more particular tasks. The term “operating system” is defined as a collection of software components that directs a computing device's operations, including controlling and scheduling the execution of other programs and managing storage, input/output and communication resources.

A “message” is defined as an electronic communication or electronic document containing information or data that is intended for one or more recipients and is sent through a wireless or wired medium or a combination of both wired and wireless media. A “message database” is defined as a component (or group of components) that receives and stores at least messages for later retrieval by authorized parties. The term “message server” is defined as a component (or group of components) that provides at least a message service for other devices that are communicatively coupled to the component (or group of components).

As noted earlier, some enterprises rely on document management systems to store, for example, messages, which may be addressed to multiple recipients. When these messages are saved into a database, the recipients will not know if a particular message has been saved without first checking the database. Even worse, some messages may be saved multiple times in the database.

To overcome these issues, a method and system for selectively tagging received messages are presented herein. In particular, a message may be delivered to a first recipient and a second recipient such that both the first recipient and the second recipient receive a copy of the message. A save command may be received from the first recipient in which the save command is a directive to save the copy of the delivered message received by the first recipient in a database that provides access rights to both the first and second recipients. In response to the copy of the delivered message received by the first recipient being saved in the database, the copy of the delivered message received by the second recipient can be tagged with a save indicator. As such, the second recipient may quickly determine that the delivered message has already been saved into a relevant database. This process can eliminate or at least minimize the possibility that the second recipient will needlessly check the database to see if the delivered message is saved or that the second recipient will repeat the unnecessary step of saving that message.

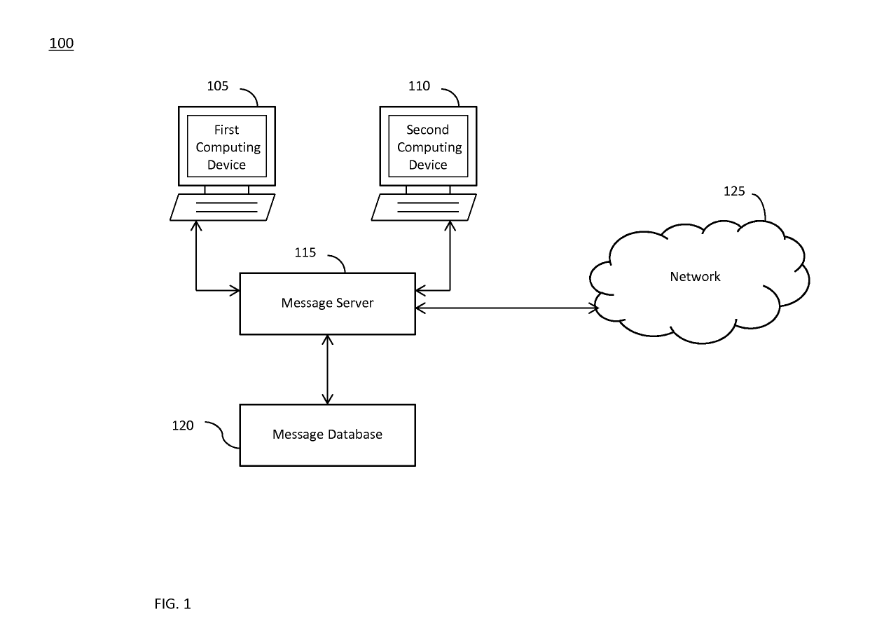

Referring to FIG. 1, a system 100 for selectively tagging received messages is shown. In one arrangement, the system 100 can include a first computing device 105 and a second computing device 110. The system 100 can also include a message server 115 and a message database 120, which may be communicatively coupled to the message server 115. In addition, the first computing device 105 and the second computing device 110 may be communicatively coupled to the message server 115. In another arrangement, the message server 115 may be communicatively coupled to a network 125, which may also be communicatively coupled to other components (not shown here). As an example, the first device 105 and the second device 110 may be part of the same computing environment, such as computing devices that are associated with the same enterprise. In this example, the message server 115 may manage the delivery, storage, retrieval and maintenance of messages on behalf of the first device 105 and the second device 110 (and possibly other devices). Also, the message database 120 may be configured to store messages on behalf of the first device 105 and the second device 110 (and possibly other devices). The message database 120, in one example, may restrict access to the messages and other information or data that the database 120 may store. In this example, only those users who can be properly authenticated may be provided with access to the stored materials.

It is important to note that the system 100 may include any suitable number of computing devices, message servers and message databases, as the system 100 is not limited to the particular arrangement shown in FIG. 1. Moreover, the first computing device 105 and the second computing device 110 are not necessarily limited to being under the control of a single enterprise. That is, the first device 105 and the second device 110 may be operated or owned by separate entities. It is also important to note that the network 125 may be an internal network that is not accessible from outside the one or more enterprises, or it can be a publicly accessible network through which persons unrelated to the enterprise(s) managing the devices 105, 110 may send messages to the devices 105, 110. The network 125 may also be a combination of private and public networks.

An example of the operation of the system 100 will now be presented. The network 125 may deliver a message to the message server 115 that is directed to the first device 105 and the second device 110. The message server 115 can receive the message and forward a copy to the first device 105 and the second device 110. Eventually, a user of the first device 105 may decide to save the copy of the message to the message database 120. At this point, the first device 105 may send a save command to the message server 115, which can be a directive to save the copy of the message delivered to the first device 105 in the database 120. In response, the message server 115 can save the copy of the message into the database 120.

Once the copy of the message from the first device 105 has been saved, the message server 115 can signal the second device 110 with this information. In response, the second device 110 may take one or more steps to inform a user of the second device 110 that the copy of the message that the second device 110 received has been saved. Examples of informing such a user will be presented below.

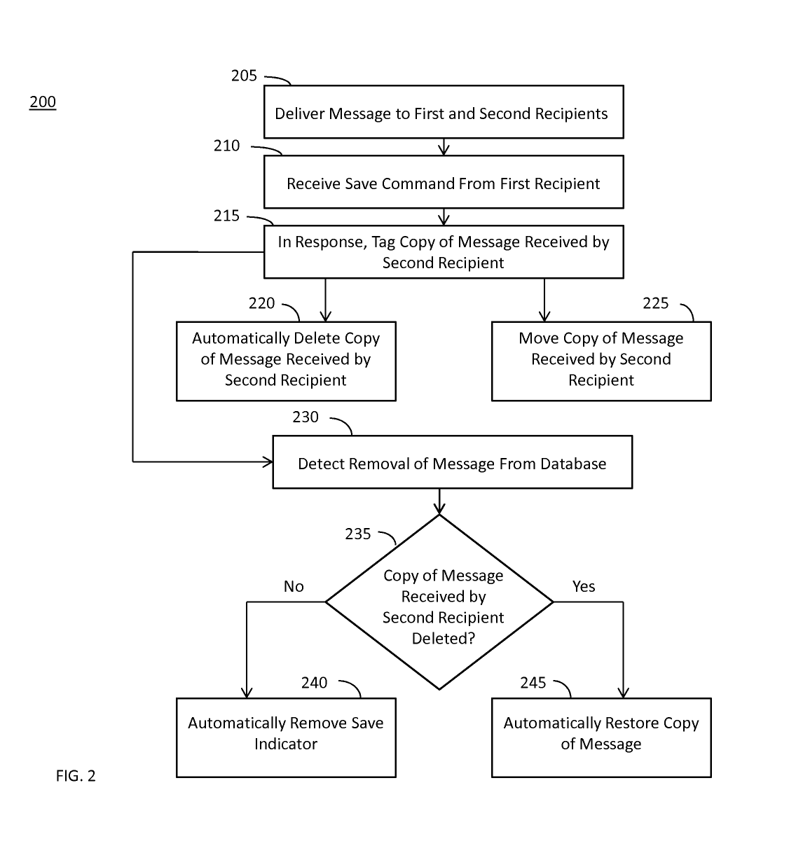

Referring to FIG. 2, a method 200 for selectively tagging received messages is shown. This method 200 is exemplary in nature, and the steps presented here are not limited to this particular chronological order. Moreover, the method 200 may be practiced with additional steps or with fewer steps in comparison to what is pictured here. References may be made to FIG. 1 to explain the method 200, but it is understood that the method 200 can be practiced with other suitable systems and components.

At step 205, a message can be delivered to a first recipient and a second recipient such that the first recipient receives a copy of the message and the second recipient receives a copy of the message. At step 210, a save command can be received from the first recipient in which the save command is a directive to save the copy of the delivered message received by the first recipient in a database that provides access rights to both the first recipient and the second recipient. In response to the copy of the delivered message received by the first recipient being saved in the database, the copy of the delivered message received by the second recipient can be tagged with a save indicator, as shown at step 215.

Once a message has been tagged, there are several alternative steps that may be taken. For example, at step 220, the copy of the delivered message received by the second recipient can be automatically deleted, such as following a predetermined time after the copy of the delivered message received by the second recipient is tagged with the save indicator. As another example, at step 225, the copy of the message received by the second recipient can be moved from a first folder to a second folder, which may be designated for messages that have been saved in the database.

In yet another example, the removal of the saved message from the database can be detected, as shown at step 230. In response to this detection, it can be determined if the copy of the message received by the second recipient has been deleted from an account associated with the second recipient, as shown at decision block 235. If the copy of the message has not been deleted, the save indicator can be automatically removed from the copy of the delivered message received by the second recipient, as shown at step 240. At step 245, if the copy has been deleted, however, the copy of the message received by the second recipient can be automatically restored to the account associated with the second recipient.

Several examples of the method 200 will now be presented. In this case, a message can be delivered to a first recipient and a second recipient, such as through the first computing device 105 and the second computing device 110, respectively. That is, a first recipient using the first device 105 can receive a copy of the delivered message, and a second recipient using the second device 110 can receive a copy of the delivered message. As a non-limiting example, the message may be an e-mail that is addressed to both the first and second recipients. Eventually, one of the first and second recipients may determine that the delivered message is important and should be saved into a database, such as the message database 120. In this example, both the first and second recipients may have the ability to save messages in and retrieve messages from the message database 120.

The first recipient, for example, may take the steps necessary to save the message in the message database 120. As a consequence, the message server 115 may receive a save command from the first recipient, which may be a directive to save the copy of the delivered message received by the first recipient in the message database 120. In response, the message server 115 can cause the copy of the message to be saved in the database 120 and may also cause the copy of the delivered message received by the second recipient to be tagged with a save indicator. The phrase “tagging the copy of the delivered message received by the recipient with a save indicator” is defined as identifying a delivered message through a human or machine perceptible form that indicates that the delivered message has been saved in a database. This process can enable the second recipient to determine that the delivered message has been saved in the message database 120.

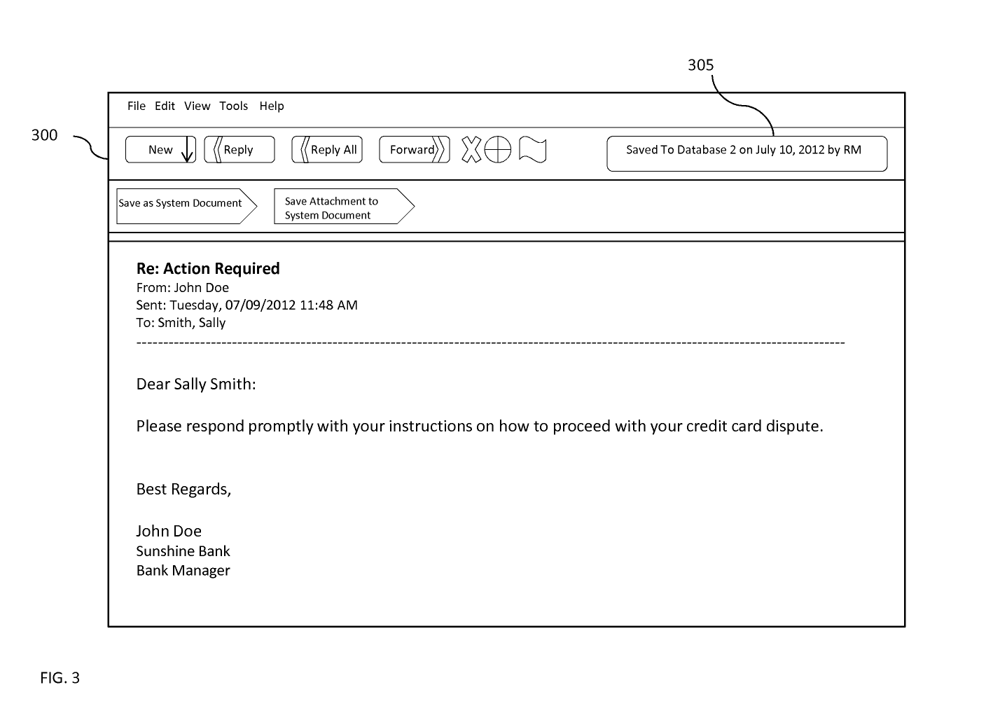

There are numerous examples of how this feature may be executed, several of which will be presented here. For example, the copy of the delivered message received by the second recipient can be tagged with a save indicator that changes the pre-existing visual characteristics of the copy of the delivered message received by the second recipient. Referring to FIG. 3, an example of a copy of a delivered message 300 is shown. This message 300 represents a copy of a delivered message that has been received by the second recipient, which may be contained in an account assigned to the second recipient. Once the first recipient saves his/her copy of the delivered message, the message 300, which is associated with the second recipient, can be tagged with a save indicator 305. In this example, the save indicator 305 may be a visual element that displays information, such as a notice that a copy of the message 300 has been saved. This notice may identify the party that saved the copy of the message 300, when it was saved and to which message database 120 it was saved. Other non-limiting examples of information that may be part of the save indicator 305 include the document type (e.g., e-mail, pdf, Word, etc.) of the saved copy, total number of pages in the saved copy or any security features employed in the copy. It is understood that the save indicator 305 is not required to include all or even any of this type of information, as the save indicator 305 may simply take the form of a colored box or some other geometric shape or phrase.

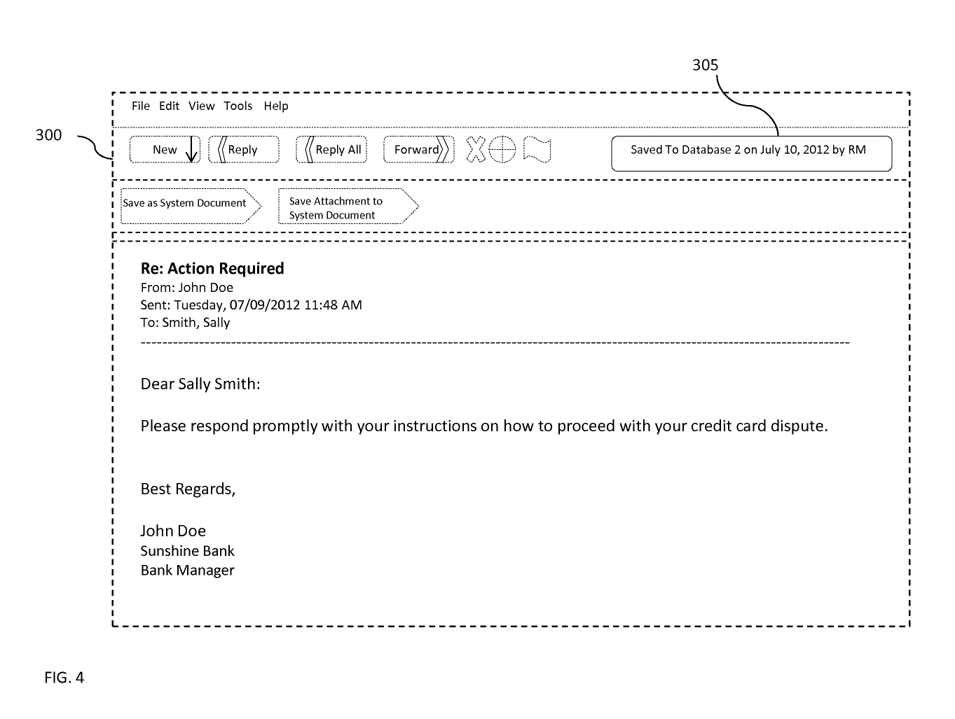

Another example of a save indicator 305 is shown in FIG. 4. In this case, all or a portion of the message 300 in the account associated with the second recipient may be faded or otherwise have its clarity impacted in some way. In this example, the fading takes the form of dashed outlines that make up the message 300. Information similar to that described above in relation to the save indicator 305 of FIG. 3 may or may not be included with this message 300.

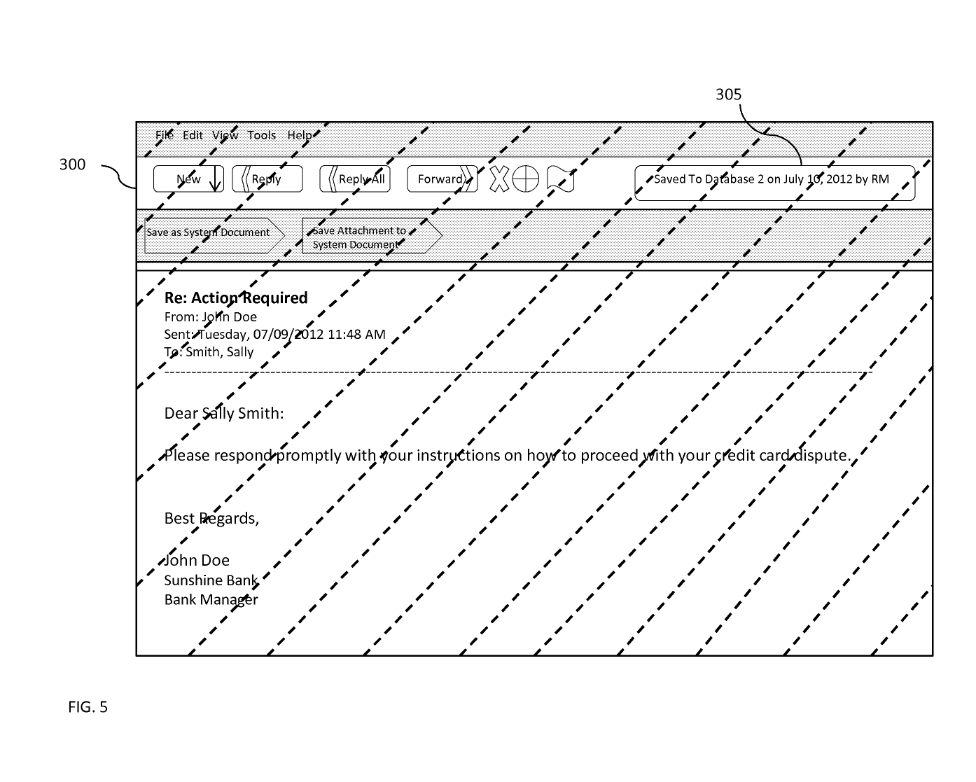

Referring to FIG. 5, another example of how a message 300 in the account associated with the second recipient may be modified when a copy of that message 300 has been saved is shown. Here, the save indicator 305 may take the form of the message 300 being shaded, which may encompass the entire message 300 or only a portion of it. The shading can be any suitable contrast to the original form of the message 300, and the original content of the message may or may not be visible. Information similar to that described above in relation to the save indicator 305 of FIG. 3 may or may not be included for a shaded message 300.

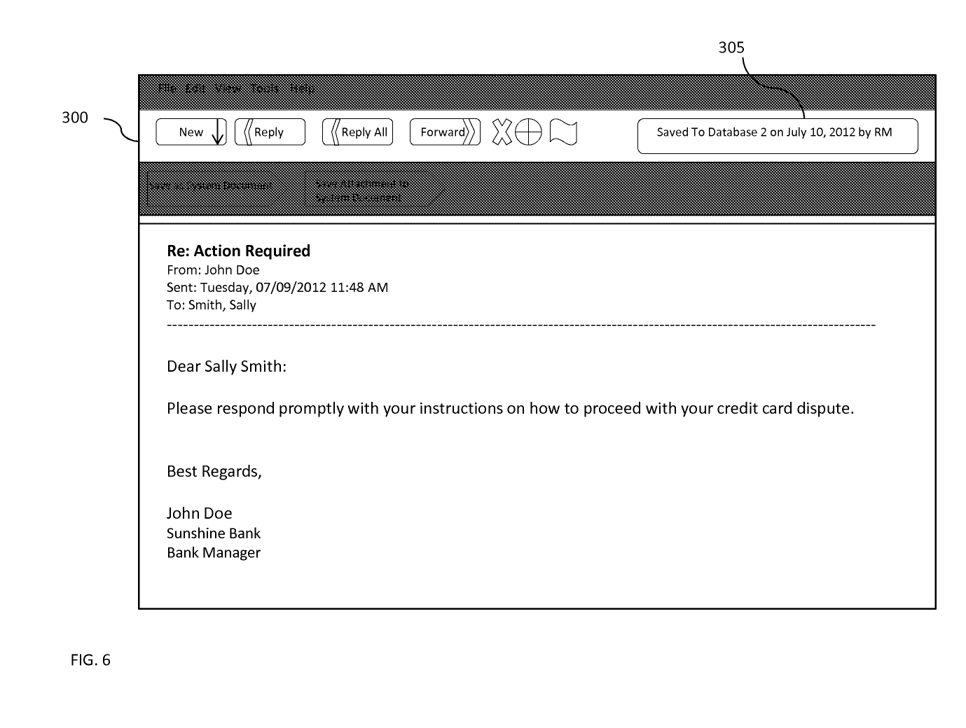

Yet another example of providing notice to the second recipient is shown in FIG. 6. In this case, the save indicator 305 may be an arrangement in which the message 300 may be colored to indicate that a copy of the message 300 has already been saved. For example, all or only a portion of the message 300 may be imbued with one or more different colors, such as the borders or content of the message 300. Again, information similar to that recited in relation to the save indicator 305 of FIG. 3 may be included in the colored message 300 of FIG. 6.

It is understood that the foregoing examples are not meant to be limiting in any way, as the message 300 may be tagged in other suitable ways. In fact, the save indicator 305 is not limited to visual means. For example, a sound may be broadcast at some suitable time, such as when the second recipient scrolls over the message 300. As another example, tactile feedback may be provided in some suitable form, such as by causing a portion of the second computing device 110 (e.g., a mouse or keyboard/keypad) to vibrate when the second recipient scrolls over the message 300. In addition, as an option, if the copy of the delivered message that is received by the first recipient is still available in the account of the first recipient, that copy may be tagged with a save indicator 305. Thus, even though the first recipient may have saved the delivered message, a save indicator 305 may serve as a reminder that the delivered message has already been saved in the relevant database. Moreover, there may be many more recipients other than the first and second recipients described in these examples, and the terms “first” and “second” is not necessarily intended to signify any chronological order in the receipt of delivered messages. A copy of the delivered message may also be saved in one or more of multiple message databases 120, with some of them prompting the tagging of the copies of the messages delivered to the other recipients, while some databases may not warrant such tagging. That is, tagging of copies of messages may be selective based on the database that receives and stores the delivered message.

There are several other options that may be available following the tagging of a message as described above. For example, the copy of the message received by the second recipient can be automatically deleted, such as after a predetermined time following the tagging of the copy of the message received by the second recipient. As a more specific example, permission to permit the automatic deletion of a tagged message associated with the account of the second recipient some time after the message is tagged may be obtained from the second recipient or some other suitable entity, such as an administrator. Obtaining permission to automatically delete such messages may be mandatory or optional. In the case of a mandatory permission arrangement, a tagged message may not be deleted unless and until permission is obtained from the relevant party. This permission may be obtained at any suitable time, including both before the delivered message is saved in a database or after the delivered message is saved. For example, if the first recipient wishes to save his/her copy of the delivered message in a database and the copy of the message received by the second recipient is to be automatically deleted, the first recipient (or some other suitable party) may be notified that permission is to be obtained from the second recipient before moving forward. Alternatively, this notification may be adjusted to be made aware to the first recipient after the first recipient saves his/her copy of the delivered message.

Another option that is available is to move the copy of the message received by the second recipient from one folder to another. For example, the second recipient may have an account that includes a first folder that maintains copies of the delivered messages and a second folder that is designated for messages that have been saved in a message database. In this example, when the first recipient saves his/her copy of the delivered message, the copy of the messages received by the second recipient may be tagged as described above and moved to the second folder. As another option, the second folder may be under the control of a party other than the second recipient or the second recipient may share access rights to this second folder with the other party.

It must be noted that the steps of automatically deleting copies of a message that has been saved or moving these copies to another folder may be performed with or without the messages being tagged. For example, if the first recipient saves his/her copy of a delivered message, the copy of the message received by the second recipient may be automatically deleted without that copy being tagged. Similarly, the copy of the messages received by the second recipient may be automatically moved to a second folder without being tagged.

Another option that may be available is the removal of a save indicator or the automatic restoration of a deleted copy of a delivered message. For example, assume that a first recipient has saved his/her copy of a delivered message into a message database. At this point, the copy of the message received by the second recipient may be tagged, as previously explained. Eventually, the copy of the message that was saved in the message database may be deleted, whether intentionally or accidentally. This deletion may be detected (such as by the message server 115), and in response, the save indicator with which the coy of the message received by the second recipient was tagged may be automatically removed. As such, the second recipient may determine that the delivered message is no longer saved in the message database 120. If desired, a notification may also be sent to the second computing device 110, which can inform the second recipient of the deletion of the delivered message from the message database 120.

If the copy of the message received by the second recipient was previously deleted, that copy may be automatically restored to the account of the second recipient, if such a process is available. That is, if the copy of the message saved by the first recipient in the message database 120 is deleted from the database 120 and the copy of the delivered message received by the second recipient was previously deleted from the account of the second recipient, the copy of the delivered message that was previously deleted may be automatically restored to the account associated with the second recipient (or some other suitable folder).

In another embodiment, a log can be maintained that records the deletion of copies of delivered messages. For example, if a first recipient saves his/her copy of a delivered message and the copy of the delivered message received by the second recipient is automatically deleted, the message server 115 (or some other suitable component) may record the deletion in a log. This way, a user may be able to determine which messages associated with the second recipient (or some other recipient) have been deleted.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the claims and their equivalents should not be limited by any of the above-described exemplary embodiments.

What is claimed is:

1. A method for selectively tagging received messages, comprising:
delivering a message to a first recipient and a second recipient such that the first recipient receives a copy of the message and the second recipient receives a copy of the message;
receiving a save command from the first recipient, wherein the save command is a directive to save the copy of the delivered message received by the first recipient in a database that provides access rights to both the first recipient and the second recipient; and
in response to the copy of the delivered message received by the first recipient being saved in the database, tagging the copy of the delivered message received by the second recipient with a save indicator to enable the second recipient to determine that the delivered message has been saved in the database.

2. The method according to claim 1, wherein the delivered message is an email that is addressed to both the first recipient and the second recipient.

3. The method according to claim 1, further comprising automatically deleting the copy of the delivered message received by the second recipient after a predetermined time after the copy of the delivered message received by the second recipient is tagged with the save indicator.

4. The method according to claim 1, wherein tagging the copy of the delivered message received by the second recipient with the save indicator comprises changing the pre-existing visual characteristics of the copy of the delivered message received by the second recipient.

5. The method according to claim 4, wherein changing the pre-existing visual characteristics of the copy of the delivered message comprises one or more of the following: fading the copy; shading the copy; displaying a graphical user interface save indicator element on the copy; or changing one or more colors of the copy.

6. The method according to claim 1, further comprising moving the copy of the message received by the second recipient from a first folder to a second folder, wherein the second folder is designated for messages that have been saved in the database.

7. The method according to claim 1, further comprising:
detecting the removal of the message from the database; and
in response to the detection, automatically removing the save indicator from the copy of the delivered message received by the second recipient.

8. The method according to claim 1, further comprising:
detecting the removal of the message from the database;
in response to the detection, determining whether the copy of the message received by the second recipient has been deleted from an account associated with the second recipient;
if the copy of the message received by the second recipient has been deleted from the account, automatically restoring the copy of the message to the account.

9. The method according to claim 1, wherein the save indicator identifies the database to which the delivered message was saved.

10. A method for managing messages, comprising:
delivering a message to a first recipient and a second recipient such that the first recipient receives a copy of the message and the second recipient receives a copy of the message;
receiving a save command from the first recipient, wherein the save command is a directive to save the copy of the delivered message received by the first recipient in a database that provides access rights to both the first recipient and the second recipient; and
in response to the copy of the delivered message received by the first recipient being saved in the database, automatically deleting the copy of the delivered message received by the second recipient.

11. The method according to claim 10, wherein automatically deleting the copy of the delivered message received by the second recipient is only performed if permission is obtained.

12. The method according to claim 11, wherein the permission is obtained either prior to the delivered message being saved in the database or after the delivered message is saved in the database.

13. The method according to claim 12, wherein the permission is obtained from the second recipient.

14. The method according to claim 10, wherein the delivered message is an email that is addressed to both the first recipient and the second recipient.

15. A system for selectively tagging received messages, comprising:
a message database, wherein the message database is configured to store a plurality of delivered messages and to provide access rights to a first recipient and a second recipient;
a message server, wherein the message server is communicatively coupled to the message database and wherein the message server is operable to:
deliver a message to the first recipient and the recipient such that the first recipient receives a copy of the message and the second recipient receives a copy of the message;
receive a save command from the first recipient;
in response to the save command, save the copy of the delivered message received by the first recipient in the message database; and
in response to saving the copy of the delivered message received by the first recipient in the message database, tag the copy of the delivered message received by the second recipient with a save indicator to enable the second recipient to determine that the delivered message has been saved in the message database.

16. The system according to claim 15, wherein the message server is operable to tag the copy of the delivered message received by the second recipient by changing the pre-existing visual characteristics of the copy of the delivered message received by the second recipient.

17. The system according to claim 16, wherein the message server is operable to change the pre-existing visual characteristics of the copy of the delivered message received by the second recipient by one or more of the following: fading the copy; shading the copy; displaying a graphical user interface save indicator element on the copy; or changing one or more colors of the copy.

18. A system for managing messages, comprising:
a message database, wherein the message database is configured to store a plurality of delivered messages and to provide access rights to a first recipient and a second recipient;
a message server, wherein the message server is communicatively coupled to the message database and wherein the message server is operable to:
deliver a message to the first recipient and the second recipient such that the first recipient receives a copy of the message and the second recipient receives a copy of the message;
receive a save command from the first recipient;
in response to the save command, save the copy of the delivered message received by the first recipient in the message database; and
in response to saving the copy of the delivered message received by the first recipient in the message database, automatically delete the copy of the delivered message received by the second recipient.

19. The system according to claim 18, wherein the message server is further operable to maintain a log that records the deletion of the delivered message received by the second recipient.

20. The system according to claim 18, wherein the message server is operable to automatically delete the copy of the delivered message received by the second recipient only if permission is obtained.

21. The system according to claim 20, wherein the permission is obtained from the second recipient.
